(19) United States
(12) Patent Application Publication
(10) Pub. No.: US 2016/0061379 A1
(43) Pub. Date: Mar. 3, 2016

(54) ATTACHMENT APPARATUS, COVER APPARATUS AND ATTACHMENT SYSTEM

(71) Applicant: Kabushiki Kaisha Toshiba, Tokyo (JP)

(72) Inventors: Jun WATANABE, Fussa Tokyo (JP); Ryo SAITO, Nerima Tokyo (JP); Satoru TANINAKA, Tachikawa Tokyo (JP); Masakazu NAKAMURA, Tachikawa Tokyo (JP)

(21) Appl. No.: 14/668,734

(22) Filed: Mar. 25, 2015

(30) Foreign Application Priority Data
Aug. 28, 2014 (JP) 2014-174501

(51) Int. Cl. F16M 11/22; G06F 1/16

(52) U.S. Cl. CPC F16M 11/22; G06F 1/1656

(57) ABSTRACT

An attachment apparatus is an attachment apparatus that an electronic device contained in a cover apparatus is attached to. The attachment apparatus includes a main body, a guiding member and a pressing member. The main body has a placement face that the cover apparatus is placed on via one side face thereof, and a contact face coming into contact with a rear face of the cover apparatus. The guiding member has an engaging part protruding from inside of the main body to the outside through an opening formed in the contact face and engaging a positioning groove of the cover apparatus in attaching of the electronic device. The pressing member is provided inside the main body and imparts a pressing force to the guiding member such that the engaging part protrudes outside of the main body by an amount according to a thickness of the cover apparatus.

### CROSS-REFERENCE TO RELATED APPLICATIONS

This application is based upon and claims the benefit of priority from the prior Japanese Patent Application No. 2014-174501, filed on Aug. 28, 2014, the entire contents of which are incorporated herein by reference.

### FIELD

Embodiments described herein relate generally to an attachment apparatus, a cover apparatus and an attachment system.

### BACKGROUND

A desktop cradle, for example, is known conventionally as an attachment apparatus for attaching an electronic device such as a tablet terminal. There is a case where the tablet terminal is attached to the attachment apparatus in a state of being contained in a cover apparatus such as a jacket.

This type of attachment apparatus includes terminals electrically connected to a connector of the tablet terminal in a state where the tablet terminal is attached. The terminals are, for example, charging terminals and the tablet terminal is charged through the charging terminals.

Conventionally, attachment apparatuses are needed to be prepared for the respective tablet terminals (or the cover apparatuses) different in thickness. Namely, the tablet terminals (or the cover apparatuses) different in thickness cannot be attached to the common attachment apparatus.

### BRIEF DESCRIPTION OF THE DRAWINGS

FIG. 1 is a lateral view an attachment system 1 representing the embodiments;

FIG. 2 is a perspective view of a cover apparatus 20 in the attachment system 1 of FIG. 1;

FIG. 3 is a perspective view of an attachment apparatus 10 in the attachment system 1 of FIG. 1;

FIG. 4A is an enlarged lateral view of a guiding member 12 in the attachment apparatus 10;

FIG. 4B is a perspective view of the guiding member 12;

FIG. 5A is an expanded sectional view illustrating a state before the cover apparatus 20 with a large thickness is attached to the attachment apparatus 10;

FIG. 5B is an expanded sectional view thereof after the cover apparatus 20 with the large thickness is attached to the attachment apparatus 10;

FIG. 6 is a schematic cross-sectional view illustrating a state where the cover apparatus 20 with a small thickness is attached the attachment apparatus 10;

FIG. 7 is an explanatory drawing for explaining operation of preventing erroneous attaching of the cover apparatus 20;

FIG. 8A is an expanded sectional view illustrating a state before the cover apparatus 20 with the large thickness is attached to the attachment apparatus 10 according to a first modification;

FIG. 8B is an expanded sectional view after the cover apparatus 20 with the small thickness is attached to the relevant attachment apparatus 10;

FIG. 9A is a rear view of the attachment system 1 according to a second modification; and

FIG. 9B is an enlarged view of the relevant attachment system 1.

### DETAILED DESCRIPTION

An attachment apparatus according to the embodiment is an attachment apparatus that an electronic device contained in a cover apparatus is attached to. The attachment apparatus includes a main body, a guiding member and a pressing member. The main body has a placement face that the cover apparatus is placed on via one side face thereof, and a contact face configured to come into contact with a rear face of the cover apparatus. The guiding member has an engaging part configured to protrude from an inside of the main body to an outside of the main body through an opening formed in the contact face and configured to engage a positioning groove of the cover apparatus in attaching of the electronic device. The pressing member is provided inside the main body and configured to impart a pressing force to the guiding member such that the engaging part protrudes to the outside of the main body by an amount according to a thickness of the cover apparatus.

Hereafter, embodiments according to the present invention are described with reference to the drawings. The embodiments do not intend to limit the present invention.

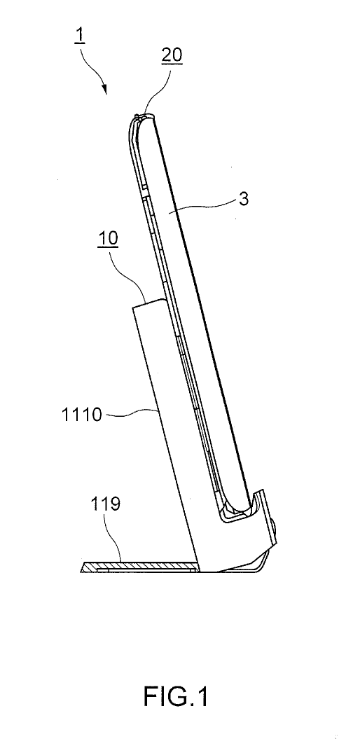

FIG. 1 is a lateral view of an attachment system 1 representing the embodiments.

As illustrated in FIG. 1, the attachment system 1 includes an attachment apparatus 10 and a cover apparatus 20 configured to contain an electronic device 3. The electronic device 3 is a device having a housing, in a rectangular plate shape with a predetermined thickness, in which a displaying device, a circuit board and the like are contained. For example, it is a tablet terminal.

To the attachment apparatus 10, the electronic device 3 contained in the cover apparatus 20 is detachably attached. Notably, the attachment apparatus 10 in FIG. 1 can be used as a desktop cradle for supporting the electronic device 3 in a state where it is inclined by a predetermined inclination on a desktop with a support 119. Moreover, the attachment apparatus 10 can also be used as a cradle for wall mounting by locking a rear face 1110 on an opposite side of a contact face 112 mentioned later in the main body 11 to a wall surface with a not-shown locking member (for example, screws, fittings or the like).

(Cover Apparatus 20)

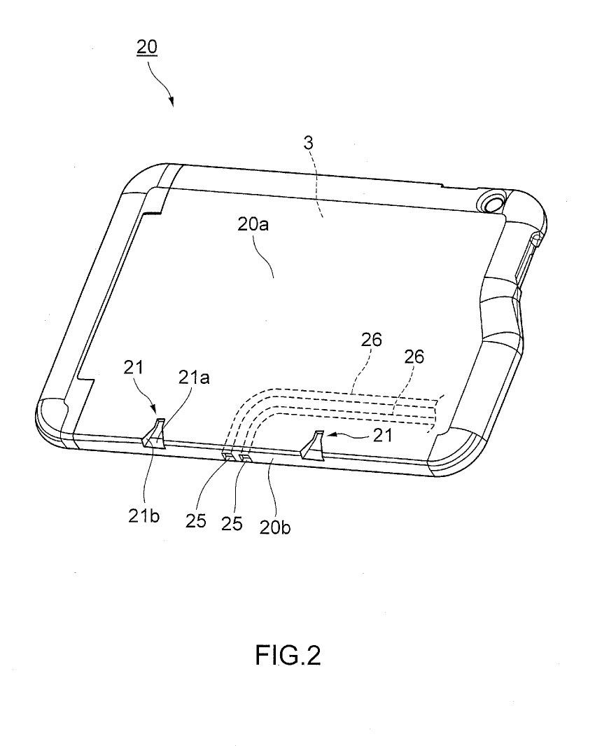

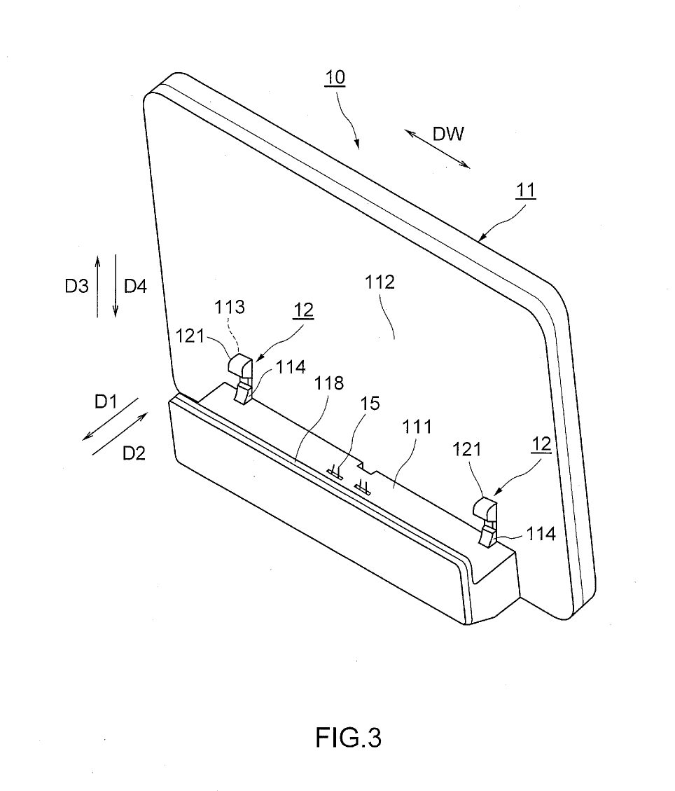

Herein, the cover apparatus 20 is first described in detail. FIG. 2 is a perspective view of the cover apparatus 20 in the attachment system 1 of FIG. 1. As illustrated in FIG. 2, the cover apparatus 20 has positioning grooves 21 on its rear face 20a. Engaging parts 121 of the attachment apparatus 10 mentioned later (refer to FIG. 3) engage the positioning grooves 21 when the electronic device is attached to the attachment apparatus 10 (hereinafter also referred to simply as “in attaching of the device”).

The positioning groove 21 extends from a lower end of the rear face 20a in a state where the electronic device 3 is attached to the attachment apparatus 10 (hereinafter also referred to simply as “attaching state of the device”) toward an upper face thereof in the attaching state of the device.

More specifically, illustrated in FIG. 2, the positioning groove 21 has a bottom inclined face 21a on its bottom face. The bottom inclined face 21a is inclined such that a groove depth of the positioning groove 21 is allowed to be shallower in a direction from the lower end of the rear face 20a toward the upper end thereof. Notably, the groove depth on the upper end side with respect to the bottom inclined face 21a may be constant.

Moreover, the positioning groove 21 has lateral inclined faces 21b on its inner lateral faces. The lateral inclined faces 21b are inclined such that a groove width of the positioning groove 21 is allowed to be wider in a direction from the upper end side of the rear face 20a toward the lower end. Notably, the groove width on the upper end side with respect to the lateral inclined faces 21b may be constant.

According to the positioning grooves 21 mentioned above, engagement with guiding members 12 (mentioned later) of the attachment apparatus 10 in attaching of the device can be made easy and positioning of the electronic device 3 can be readily performed.

Charging terminals 25 are provided on one side face (hereinafter also referred to as bottom face) 20b, of the cover apparatus 20, on which the positioning grooves 21 are formed. The charging terminals 25 are connected to a connector of the electronic device 3 through lines 26.

(Attachment Apparatus 10)

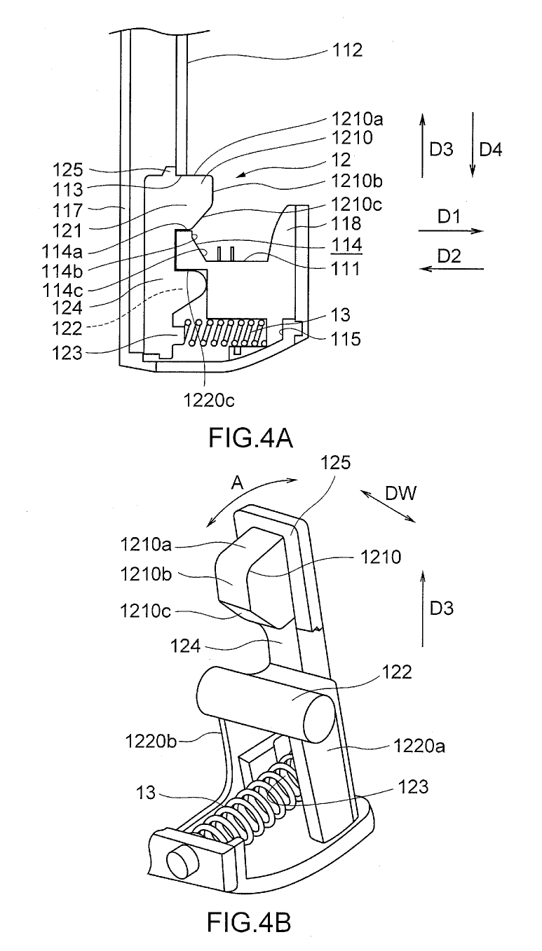

Next, the attachment apparatus 10 is described in detail. FIG. 3 is a perspective view of the attachment apparatus 10 in the attachment system 1 of FIG. 1. FIGS. 4A and 4B are enlarged views of the guiding member 12 in the attachment apparatus 10 of FIG. 3. More in detail, FIG. 4A is a schematic cross-sectional view of the guiding member 12 and FIG. 4B is a perspective view of the guiding member 12. As illustrated in FIG. 3 and FIGS. 4A and 4B, the attachment apparatus 10 has a main body 11, two guiding members 12, and two pressing members 13 which are compression springs.

(Main Body 11)

The main body 11 is a hollow housing and has a placement face 111 on which the cover apparatus 20 is placed via the bottom face 20b, and a contact face 112 which comes into contact with the rear face 20a of the cover apparatus 20. The placement face 111 projects from the contact face 112 in a forward direction D1 and is formed to be longitudinal in a width direction DW of the attachment apparatus 10.

As illustrated in FIG. 3, the contact face 112 has a pair of openings 113. The pair of openings 113 are provided in the contact face 112 and close to both end portions of the placement face 111 in the width direction DW. The opening 113 is formed into a substantially rectangular shape to meet the shape of the engaging part 121. The guiding member 12 is configured such that the engaging part 121 (mentioned later) engages the cover apparatus 20 through the opening 113.

As illustrated in FIG. 3 and FIG. 4A, protrusions 114 protruding from the contact face 112 in the forward direction D1 are provided in lower portions of the openings 113. As illustrated in FIG. 4A, the protrusion 114 has an extending face 114a extending from an inner circumferential face of the opening 113 in the forward direction D1, a descending face 114b descending vertically from a front end of the extending face 114a, and an inclined face 114c extending in a forward and downward direction from a lower end of the descending face 114b. The protrusion 114 protrudes, at a portion of the inclined face 114c, beyond a position of the engaging part 121 that is in the attaching state of the cover apparatus 20 with a large thickness in the forward direction D1. Thereby, as described later again in detail with reference to the drawings, the protrusion 114 can prevent erroneous attaching of the cover apparatus 20 with a small thickness.

As illustrated in FIG. 3, a protruding wall 118 protruding in an upward direction D3 is formed on a front end of the placement face 111. The protruding wall 118 retains the electronic device 3 such that the electronic device 3 contained in the cover apparatus 20 does not fall off the attachment apparatus 10.

Charging terminals 15 protrude at a center of the placement face 111. The charging terminals 15 come into contact with the charging terminals 25 of the cover apparatus 20 in attaching of the device.

(Guiding Member 12)

Each of the two guiding members 12 includes the engaging part 121, a rotation shaft 122, a pressing member attaching part 123 and an arm 124. The guiding members 12 may be integrally formed of a plastic material.

(Arm 124)

As illustrated in FIG. 4A, the arm 124 extends upward and downward inside the main body 11. An upper end portion of the arm 124 reaches an upper end of the opening 113 and a lower end portion of the arm 124 comes close to a position of an inner bottom face of the main body 11.

In this way, the arm 124 extending upward and downward joins the engaging part 121, the rotation shaft 122 and the pressing member attaching part 123 together. Namely, the engaging part 121 is formed so as to protrude at the upper end of the arm 124 in the forward direction D1. The pressing member attaching part 123 is formed so as to slightly protrude at a position close to a lower end of the arm 124 in the forward direction D1. The rotation shaft 122 is formed at a position between the engaging part 121 and the pressing member attaching part 123 in the arm 124 so as to be positioned beyond the arm 124 in the forward direction D1.

(Rotation Shaft 122)

As illustrated in FIG. 4B, the rotation shaft 122 is supported at both ends thereof in an axis direction of the rotation shaft 122 by a pair of lower bearings 1220a and 1220b which are provided to stand on the inner bottom face of the main body 11. Moreover, as illustrated in FIG. 4A, the rotation shaft 122 is supported, from the upside, at an upper portion of the rotation shaft 122 by an upper bearing 1220c composed of a plane opposing the placement face 111. In this way, the rotation shaft 122 is freely rotatably supported inside the main body 11. Thereby, the guiding member 12 can rotate around the rotation shaft 122 in a rotation direction indicated by an arrow A in FIG. 4B. It should be noted that a configuration for supporting the rotation shaft 122 is not limited to the mode illustrated in FIGS. 4A and 4B.

(Engaging Part 121)

The engaging part 121 protrudes from the inside of the main body 11 to the outside of the main body 11 through the opening 113. As illustrated in FIG. 4A, the engaging part 121 has an upper face 1210a extending forward from the arm 124, a front face 1210b extending downward from a front end of the upper face 1210a, and an inclined face 1210c extending in a backward and downward direction from a lower end of the front face 1210b. The upper face 1210a is substantially parallel to the placement face 111 in a state where the electronic device 3 is not attached to the attachment apparatus 10 (hereinafter also referred to as non-attaching state). A connection part of the upper face 1210a and the front face 1210b is configured to be a corner 1210. As mentioned later, the corner 1210 prevents erroneous attaching of the electronic device 3. As mentioned later, the engaging part 121 engages the positioning groove 21 of the cover apparatus 20 in attaching of the device.

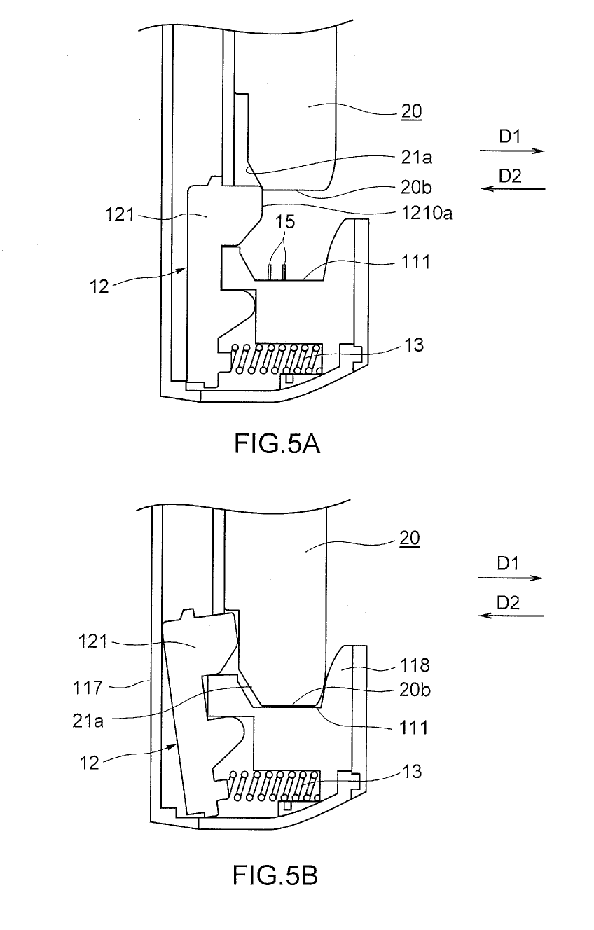

As illustrated in FIG. 4B, a rotation regulator 125 composed of a protruding edge protruding with respect to the engaging part 121 in the upward direction D3 and in the width direction DW is formed in a rear portion of the engaging part 121. An outer circumference of the rotation regulator 125 is formed to be larger than an inner circumference of the opening 113. The rotation regulator 125 butts against an edge portion of the opening 113 from the inside of the main body 11 to regulate the rotation of the engaging part 121 (guiding member 12) in a direction to the outside of the main body 11. Providing the rotation regulator 125 can prevent that the attaching of the electronic device 3 is prohibited by the engaging part 121 protruding too much in the forward direction D1. Notably, the regulation of the rotation of the engaging part 121 in a backward direction D2 is performed, for example, by the guiding member 12 brought into contact with a rear wall 117 (refer to FIG. 5B).

(Pressing Member Attaching Part 123; Pressing Member 13)

As illustrated in FIG. 4A, a rear end (one end) of the pressing member 13 is attached to the pressing member attaching part 123. A front end (another end) of the pressing member 13 is attached to an inner wall 115 of the main body 11. The pressing member 13 is disposed below the placement face 111 such that a restricted interior of the main body 11 is effectively used. The pressing member 13 imparts a pressing force, that is, an elastic force in the backward direction D2. to the pressing member attaching part 123. The rotation shaft 122 converts the pressing force of the pressing member 13 into rotational force clockwise in FIG. 4A.

By doing so, the pressing member 13 can impart the pressing force to the guiding member 12 such that the engaging part 121 protrudes to the outside of the main body 11 by an amount according to a thickness of the cover apparatus 20 in attaching of the device. Namely, the pressing member 13 causes the guiding member 12 to rotate around the rotation shaft 122 in attaching of the device. Thereby, it causes the engaging part 121 to protrude to the outside of the main body 11 by the amount according to the thickness of the cover apparatus 20.

(Operation in Attaching Cover Apparatus 20 with Large Thickness)

Next, operation in attaching the cover apparatus 20 with a large thickness (that is, with a first thickness) relative to the attachment apparatus is described. FIGS. 5A and 5B are explanatory drawings for explaining operation in attaching the cover apparatus 20 with a large thickness. More in detail, FIG. 5A is a schematic cross-sectional view illustrating the cover apparatus 20 and the guiding member 12 in starting the attaching. FIG. 5B is a schematic cross-sectional view illustrating the cover apparatus 20 and the guiding member 12 in completing the attaching.

Notably, in the initial state, it is supposed that the attachment apparatus 10 is in the non-attaching state. In the non-attaching state, the engaging part 121 is caused to move to the position where it most protrudes in the forward direction D1 with the pressing force of the pressing member 13, that is, the position where it is regulated by the rotation regulator 125 in regard to its rotation.

Then, apart from the initial state, as illustrated in FIG. 5A, when the cover apparatus 20 is to be attached onto the placement face 111 with the bottom face 20b being at first, the bottom inclined face 21a of the positioning groove 21 first comes into contact with the corner 1210 of the engaging part 121. Due to this abutting, a component of the pressing force of the cover apparatus 20 in the backward direction D2 (hereinafter also referred to simply as “pressing force of the cover apparatus 20”) acts on the engaging part 121. This pressing force of the cover apparatus 20 surpasses the pressing force of the pressing member 13. Accordingly, the guiding member 12 rotates around the rotation shaft 122 in a reverse direction to the rotation direction due to the pressing force of the pressing member 13. (counterclockwise in FIG. 5A). Thereby, the engaging part 121 is retracted by an amount according to the thickness of the cover apparatus 20 in a direction to the inside of the main body 11, that is, in the backward direction D2.

Then, as illustrated in FIG. 5B, the bottom face 20b of the cover apparatus 20 comes into contact with the placement face 111, so that the charging terminals 25 of the cover apparatus 20 come into contact with the charging terminals 15 of the placement face 111. Thereby, the attaching of the cover apparatus 20 is completed.

In this stage, the engaging part 121 protrudes to the outside of the main body 11, pressing the positioning groove 21 with the pressing force of the pressing member 13. Namely, the engaging part 121 protrudes to the outside of the main body 11 by the amount according to the thickness of the cover apparatus 20 with the pressing member 13.

As above, according to the attachment apparatus 10 in the embodiment, the cover apparatus 20 (electronic device 3) with a large thickness can be properly attached.

(Operation in Attaching Cover Apparatus 20 with Small Thickness)

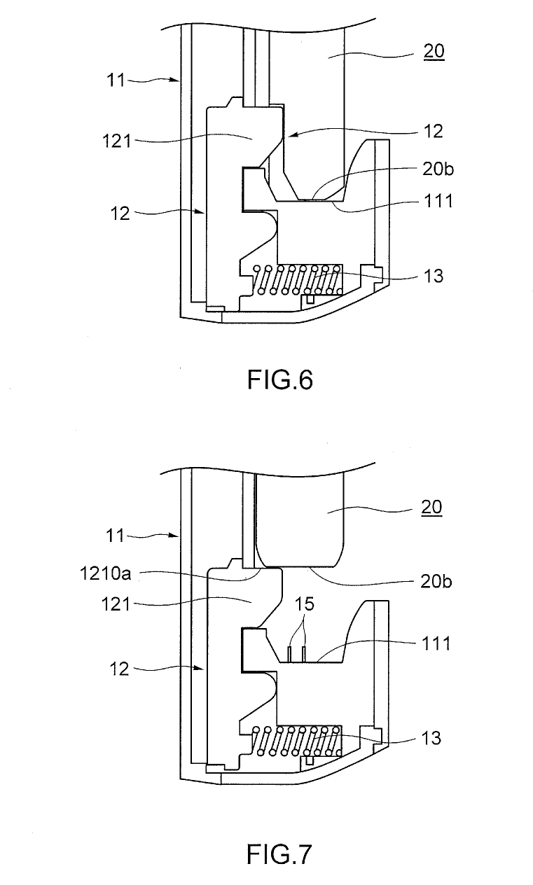

Next, operation in attaching the cover apparatus 20 with a small thickness (that is, with a second thickness) relative to the attachment apparatus 10 is described. FIG. 6 is a schematic cross-sectional view illustrating an attaching state of the cover apparatus 20 with a small thickness.

As illustrating in FIG. 6, in attaching of the cover apparatus 20 with the small thickness, the pressing force of the cover apparatus 20 hardly acts on the engaging part 121 and the attaching is completed with the engaging part 121 maintained almost at the position in the initial state. The rotational angle of the engaging part 121 in the completion state of the attaching depends on a dimension of the placement face 111 in the forward and backward direction, the thickness of the cover apparatus 20, a dimension of the engaging part 121 in the forward and backward direction, and the like.

As above, according to the attachment apparatus 10 in the embodiment, the cover apparatus 20 with a small thickness can also be attached.

(Operation of Preventing Erroneous Attaching)

Next, operation of preventing erroneous attaching with the attachment apparatus 10 is described. FIG. 7 is an explanatory drawing for explaining operation of preventing erroneous attaching.

When the cover apparatus 20 with the large thickness is to be attached by mistake in a state where the positioning groove 21 is displaced with respect to the engaging part 121 in the width direction DW, as illustrated in FIG. 7, the pressing force acts on the upper face 1210a of the corner 1210 downward vertically with the bottom face 20b of the cover apparatus 20.

In this stage, since the upper face 1210a is substantially parallel to the placement face 111, the pressing force of the cover apparatus 20 hardly has a component in the backward direction D2. Accordingly, the pressing force of the cover apparatus 20 is not converted into the rotational force of the guiding member 12 and the guiding member 12 maintains its position in the non-attaching state. In this way, since the cover apparatus 20 cannot retract the engaging part 121 in the direction of the inside of the main body 11 even under pressing the upper face 1210a, it is prohibited from proceeding to the placement face 111 side due to the normal reaction from the upper face 1210a. As above, erroneous attaching of the cover apparatus 20 with the large thickness can be prevented.

On the other hand, as to the cover apparatus 20 with the small thickness, erroneous attaching can be prevented with the protrusion 114. Namely, when the cover apparatus 20 with the small thickness is to be attached by mistake in a state where the positioning groove 21 is displaced with respect to the engaging part 121 in the width direction DW, the cover apparatus 20 comes into contact with any position on the protrusion 114 (for example, the inclined face 114c). Thereby, it is prohibited from proceeding to the placement face 111 side. As above, erroneous attaching of the cover apparatus 20 with the small thickness can also be prevented.

As described above, according to the embodiment, the pressing force of the pressing member 13 can cause the engaging part 121 to protrude to the outside of the main body 11 by the amount according to the thickness of the cover apparatus 20. Thereby, the electronic devices 3 different in thickness can be attached. Notably, while the description above represents two kinds of thicknesses of the cover apparatus 20 (first thickness; second thickness), according to the embodiment, three or more kinds of the cover apparatuses 20 (electronic devices 3) different in thickness can be attached.

(First Modification)

Next, a first modification of the embodiment is described.

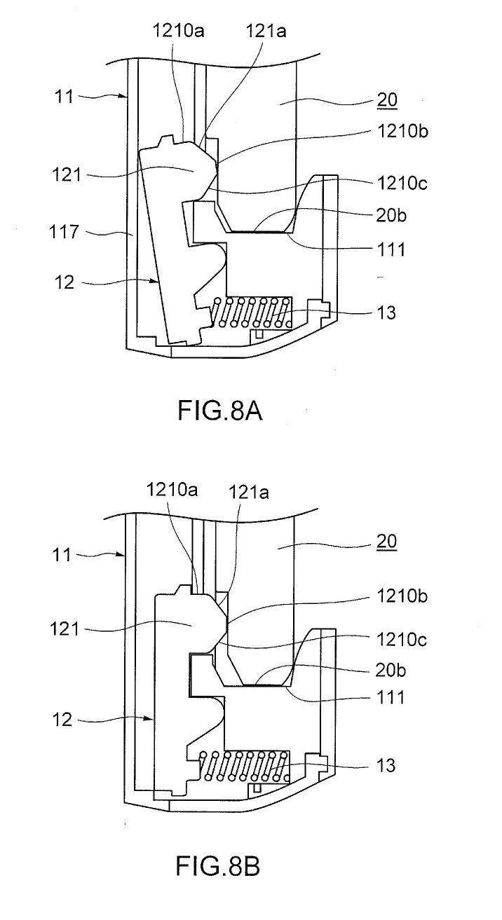

FIGS. 8A and 8B are schematic cross-sectional views illustrating a first modification of the attachment system 1. More in detail, FIG. 8A is a schematic cross-sectional view illustrating an attaching state of the cover apparatus 20 with the large thickness. FIG. 8B is a schematic cross-sectional view illustrating an attaching state of the cover apparatus 20 with the small thickness. The engaging part 121 in the modification has an inclined face 121a connecting the front end of the upper face 1210a and the upper end of the front face 1210b together in place of the corner 1210 illustrated in FIGS. 4A and 4B. The inclined face 121a is inclined so as to depart from the contact face 112 in a direction toward the placement face 111 in the non-attaching state. In the modification, the lower end of the positioning groove 21 is caused to come into contact with the inclined face 121a in attaching of the device. Thereby, the engaging part 121 can be readily retracted backward.

(Second Modification)

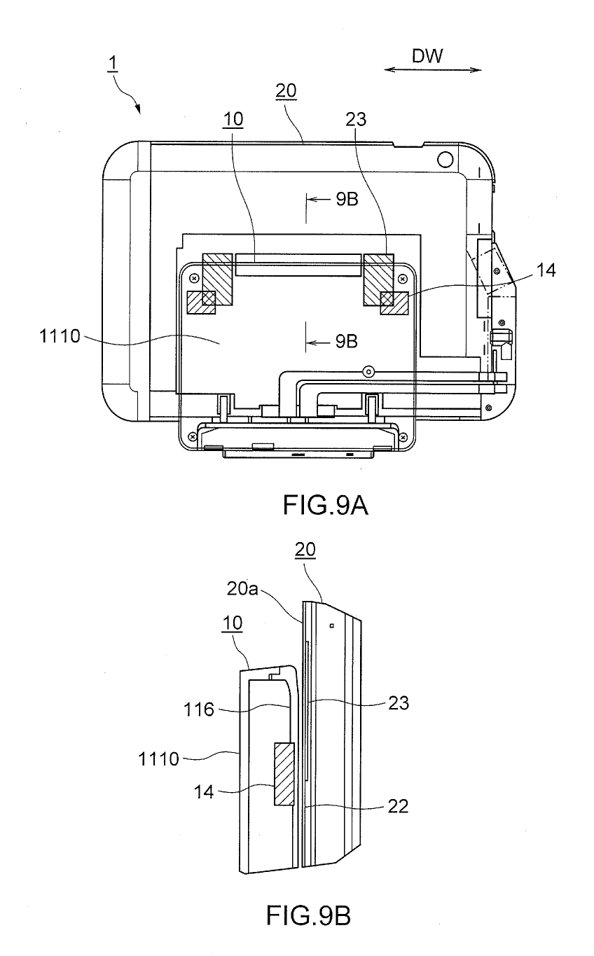

Next, a second modification of the embodiment is described. FIGS. 9A and 9B are diagrams illustrating a second modification of the attachment system 1. More in detail, FIG. 9A is a rear view of the attachment system 1. FIG. 9B is a schematic diagram of a cross-section taken along the line 9B-9B in FIG. 9A. In the modification, the main body 11 has magnets 14 disposed on an inner wall surface 116 opposite to the contact face 112. Moreover, in the modification, the cover apparatus 20 includes ferromagnetic bodies 23 fixed on a backside 22 of the rear face 20a. The ferromagnetic body 23 may be, for example, an iron plate but is not limited to this. The magnet 14 is disposed partially on the placement face 111 side relative to the ferromagnetic body 23. More specifically, as illustrated in FIGS. 9A and 9B, an upper end of the magnet 14 is positioned above a lower end of the ferromagnetic body 23 and a lower end of the magnet 14 is positioned below the lower end of the ferromagnetic body 23. Notably, as illustrated in FIG. 9A, the ferromagnetic bodies 23 may be positioned inside the magnets 14 in the width direction DW.

Notably, the magnets 14 and the ferromagnetic bodies 23 may be disposed such that a range in which the magnets 14 overlap with the ferromagnetic bodies 23 is different according to a size or a weight of the electronic device 3 contained in the cover apparatus 20 when the cover apparatus 20 is placed on the main body 11. For example, the larger the size or the weight of the electronic device 3 contained in the cover apparatus 20 is, the larger an area in which the magnets 14 overlap with the ferromagnetic bodies 23 may be. By doing so, even in the case of a heavy electronic device, larger magnetic force can be secured and it can be retained on the attachment apparatus 10 more securely.

According to the modification, the magnets 14 of the attachment apparatus 10 cause magnetic force in a direction where the cover apparatus 20 is attached to act on the ferromagnetic bodies 23 of the cover apparatus 20 in attaching of the device. Thereby, the cover apparatus 20 can be readily attached. Furthermore, the cover apparatus 20 can be prevented from coming off the attachment apparatus 10.

Moreover, as illustrated in FIG. 9B, according to the modification, the magnets 14 partially overlap with the ferromagnetic bodies 23 in the forward and backward direction. Thereby, the attaching state of the cover apparatus 20 can be stably maintained.

Furthermore, according to the modification, the lower end of the ferromagnetic body 23 can be positioned above the lower end of the magnet 14. Hence, the downward magnetic force acting on the ferromagnetic body 23 can be configured to be not too large. Thereby, the cover apparatus 20 can also be readily detached.

Furthermore, according to the modification, an area in which the magnets 14 overlap with the magnetic bodies 23 may be configured to be large. Thereby, larger magnetic force can be secured such that even a heavy article can be securely retained. The magnitude of the magnetic force can be adjusted to match a device to be attached. The attachment apparatus 10 as above according to the modification has an added value that restriction to the weight can be released as well as restriction to the thickness of the electronic device to be attached as a cradle for wall mounting.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An attachment apparatus for attaching an electronic device contained in a cover apparatus, the attachment apparatus comprising:
a main body comprising a placement face for placing one side face of the cover apparatus and a contact face configured to come into contact with a rear face of the cover apparatus;
a guiding member comprising an engaging part configured to protrude from the main body through an opening formed in the contact face and configured to engage with a positioning groove of the cover apparatus to attache the electronic device; and
a pressing member provided inside the main body and configured to impart a pressing force to the guiding member such that the engaging part protrudes from the main body by an amount based on a thickness of the cover apparatus.

2. The attachment apparatus of claim 1, wherein
the guiding member comprises a rotation shaft freely and rotatably supported by the main body, and
the engaging part protrudes from the main body by the amount based on rotation of the guiding member around the rotation shaft.

3. The attachment apparatus of claim 1, capable of being hung by locking a rear face opposite of the contact face.

4. The attachment apparatus of claim 1, wherein
the engaging part comprises a corner including an upper face parallel to the placement face in a state where the electronic device is not attached.

5. The attachment apparatus of claim 2, wherein the engaging part comprises a corner including an upper face parallel to the placement face in a state where the electronic device is not attached.

6. The attachment apparatus of claim 1, wherein
the engaging part comprises an upper face parallel to the placement face in a state where the electronic device is not attached, and an inclined face connected to the upper face and inclined so as to depart from the contact face in a direction toward the placement face.

7. The attachment apparatus of claim 1, further comprising a protrusion in a lower portion of the opening so as to protrude from the contact face.

8. The attachment apparatus of claim 2, further comprising a protrusion in a lower portion of the opening so as to protrude from the contact face.

9. The attachment apparatus of claim 7, wherein
the protrusion protrudes beyond a position of the engaging part when the cover apparatus with the thickness greater than a first thickness is attached.

10. The attachment apparatus of claim 2, wherein
the guiding member has a pressing member attaching part wherein one end of the pressing member is attached to and an arm configured to join the pressing member attaching part, the rotation shaft and the engaging part together.

11. The attachment apparatus of claim 10, wherein
the pressing member is a compression spring whose other end is attached to an inner wall of the main body.

12. The attachment apparatus of claim 1, wherein
the guiding member comprises a rotation regulator configured to regulate protrusion of the engaging part from the main body by butting against an edge of the opening in the main body.

13. The attachment apparatus of claim 2, wherein
the guiding member comprises a rotation regulator configured to regulate protrusion of the engaging part from the main body by butting against an edge of the opening in the main body.

14. A cover apparatus capable of containing an electronic device for attaching the electronic device to an attachment apparatus, the cover apparatus comprising
a positioning groove capable of engaging an engaging part of the attachment apparatus for attaching the electronic device,
the positioning groove extending in a rear face of the cover apparatus from a lower end of the rear face toward an upper end of the rear face and becoming shallower in groove depth in a direction toward the upper end.

15. The cover apparatus of claim 14, wherein
the positioning groove becomes wider in groove width in a direction from a side of the upper end of the rear face toward the lower end.

16. The cover apparatus of claim 14, wherein
the attachment apparatus has a main body having a placement face for placing one side face of the cover apparatus and a contact face configured to come into contact with the rear face of the cover apparatus,
the main body has a magnet fixed to an inner wall surface opposite the contact face,
the cover apparatus includes a ferromagnetic body fixed to a backside of the rear face, and
the magnet is larger on a side of the placement face than the ferromagnetic body.

17. The cover apparatus of claim 15, wherein
the attachment apparatus has a main body having a placement face for placing one side face of the cover apparatus and a contact face configured to come into contact with the rear face of the cover apparatus.
the main body has a magnet fixed to an inner wall surface opposite the contact face,
the cover apparatus includes a ferromagnetic body fixed to a backside of the rear face, and
the magnet is larger on a side of the placement face than the ferromagnetic body.

18. The cover apparatus of claim 16, wherein the magnet and the ferromagnetic body are disposed such that a range that the magnet overlaps with the ferromagnetic body when the cover apparatus is placed on the main body is different according to a size or a weight of the electronic device contained in the cover apparatus.

19. An attachment system comprising:
a cover apparatus; and
an attachment apparatus for attaching an electronic device contained in the cover apparatus,
the attachment apparatus including
a main body comprising a placement face for placing one side face of the cover apparatus and a contact face configured to come into contact with a rear face of the cover apparatus,
a guiding member having an engaging part configured to protrude from the main body through an opening formed in the contact face and configured to engage with a positioning groove of the cover apparatus in attaching the electronic device, and
a pressing member in the main body and configured to impart a pressing force to the guiding member such that the engaging part protrudes from the main body by an amount based on a thickness of the cover apparatus.

20. The attachment system of claim 19, wherein
the positioning groove extends in the rear face of the cover apparatus from a lower end toward an upper end of the rear face and becomes shallower in groove depth in a direction toward the upper end.
